(19) United States
(12) Patent Application Publication
(10) Pub. No.: US 2021/0334790 A1
(43) Pub. Date: Oct. 28, 2021

(54) SERVER, WALLET SYSTEM, COMPUTER READABLE RECORDING MEDIUM, AND NOTIFICATION METHOD

(71) Applicant: TOYOTA JIDOSHA KABUSHIKI KAISHA, Toyota-shi (JP)

(72) Inventors: Kenji OKAZAKI, Toyota-shi (JP); Masato ENDO, Chofu-shi (JP); Mayumi KURITA, Tokyo (JP); Masashi TORITANI, Tokyo (JP); Kumiko MATSUURA, Tokyo (JP); Takayuki SHIKODA, Tokyo (JP); Masaaki OTSUKA, Kawasaki-shi (JP); Yoshikazu ISHII, Nagoya-shi (JP)

(73) Assignee: TOYOTA JIDOSHA KABUSHIKI KAISHA, Toyota-shi (JP)

(21) Appl. No.: 17/217,004

(22) Filed: Mar. 30, 2021

(30) Foreign Application Priority Data
Apr. 22, 2020 (JP) 2020-076226

(51) Int. Cl. G06Q 20/36; G06Q 20/40; G06Q 20/32

(52) U.S. Cl. CPC G06Q 20/3676; G06Q 20/3224; G06Q 20/401

(57) ABSTRACT

A server includes a processor including hardware, the processor being configured to: acquire position information of a terminal; acquire shop information in which shop position information of each of a plurality of shops and one or more settlement methods usable in each of the plurality of shops are associated with each other, and acquires user information in which the plurality of settlement methods registered on the terminal and user's balance linked with the terminal for each of the plurality of settlement methods are associated with each other; and output balance information in which the shop position information regarding a shop and the balance regarding the settlement method usable on the terminal are associated with each other to the terminal based on the position information, the shop information, and the user information.

The present application claims priority to and incorporates by reference the entire contents of Japanese Patent Application No. 2020-076226 filed in Japan on Apr. 22, 2020.

### BACKGROUND

The present disclosure relates to a server, a wallet system, a computer readable recording medium, and a notification method.

JP 2011-048484 A discloses a technique of displaying balance information regarding electronic money after a settlement on a display unit of a mobile phone when a user makes the settlement with the electronic money on a settlement terminal using the mobile phone.

### SUMMARY

The user has registered a plurality of settlement methods to a terminal such as a mobile phone. Furthermore, usable settlement methods are different depending on individual shops. Unfortunately, however, JP 2011-048484 A merely displays the balance of one type of settlement method. Therefore, the user who has registered a plurality of settlement methods has not been able to have prior knowledge of the balance regarding the settlement methods corresponding to individual stores.

There is a need for a server, a wallet system, a computer readable recording medium, and a notification method capable of having prior knowledge of the balance regarding settlement methods corresponding to individual shops.

According to one aspect of the present disclosure, there is provided a server including a processor including hardware, the processor being configured to: acquire position information of a terminal; acquire shop information in which shop position information of each of a plurality of shops and one or more settlement methods usable in each of the plurality of shops are associated with each other, and acquires user information in which the plurality of settlement methods registered on the terminal and user's balance linked with the terminal for each of the plurality of settlement methods are associated with each other; and output balance information in which the shop position information regarding a shop and the balance regarding the settlement method usable on the terminal are associated with each other to the terminal based on the position information, the shop information, and the user information.

### BRIEF DESCRIPTION OF THE DRAWINGS

FIG. 1 is a diagram schematically illustrating a configuration of a wallet system according to an embodiment;

FIG. 2 is a block diagram illustrating details of individual components of a wallet system according to the embodiment;

FIG. 3 is a flowchart illustrating an outline of the processes executed by a wallet server according to the embodiment;

FIG. 4 is a view illustrating an example of an image displayed by a user terminal according to the embodiment; and

FIG. 5 is a view illustrating an example of another image displayed by a user terminal according to the embodiment.

### DETAILED DESCRIPTIONS

Hereinafter, a wallet system including a shop terminal according to an embodiment of the present disclosure will be described with reference to the drawings. Note that the present disclosure is not limited to the following embodiment.

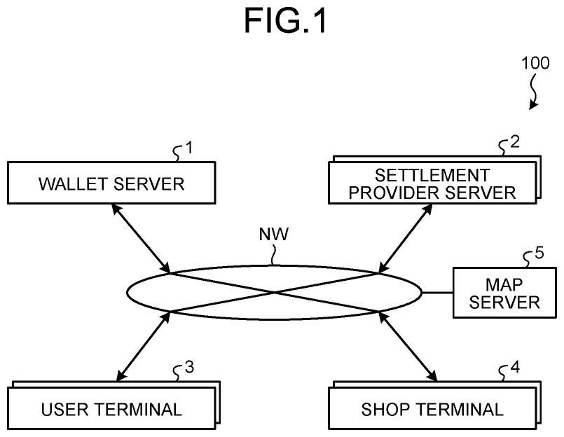

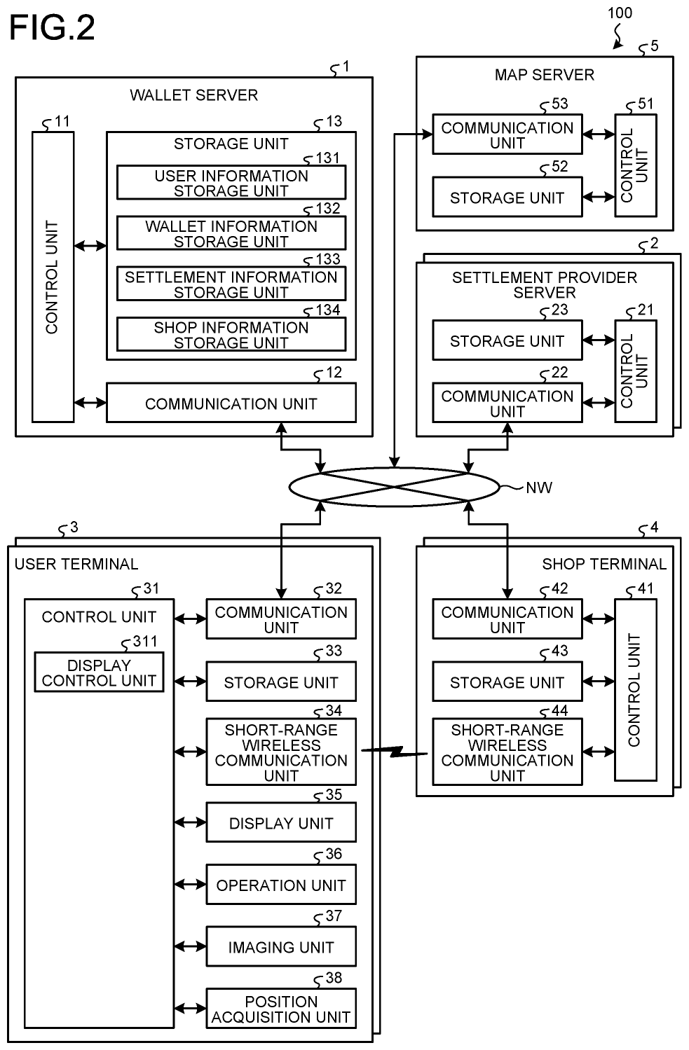

FIG. 1 is a diagram schematically illustrating a configuration of a wallet system according to an embodiment. FIG. 2 is a block diagram illustrating details of individual components of a wallet system according to the embodiment. A wallet system 100 illustrated in FIGS. 1 and 2 includes a wallet server 1, a settlement provider server 2, a user terminal 3, a shop terminal 4, and a map server 5. The wallet system 100 has a configuration capable of mutual communication through the network NW. The network NW is composed of, for example, an internet network, a mobile phone network, or the like.

First, the configuration of the wallet server 1 will be described. The wallet server 1 is a server for comprehensively managing the wallet system 100. The wallet server 1 includes a control unit 11 (second processor), a communication unit 12, and a storage unit 13.

The control unit 11 controls individual component of the wallet server 1. The control unit 11 includes: a processor having hardware such as a Central Processing Unit (CPU) and a Field-Programmable Gate Array (FPGA); and memory (main storage unit) including Random Access Memory (RAM) and Read Only Memory (ROM). The control unit 11 loads the program stored in the storage unit 13 into a work area of the main storage unit and executes the program. Through execution of the program, the control unit 11 controls individual components.

The communication unit 12 is connected to the network NW such as the Internet, which is a public communication network, and communicates with each of the settlement provider server 2, the user terminal 3, and the shop terminal 4 via the network NW. The communication unit 12 is implemented by using, for example, a Local Area Network (LAN) interface board, a wireless communication circuit for wireless communication, or the like.

The storage unit 13 stores various programs executed by the wallet server 1. The storage unit 13 is implemented by using a Hard Disk Drive (HDD), a Solid State Drive (SSD), or the like. Furthermore, the storage unit 13 includes a user information storage unit 131 for each of users in the wallet system 100, a wallet information storage unit 132, a settlement information storage unit 133, and a shop information storage unit 134 (memory).

The user information storage unit 131 stores user information related to a user who uses the wallet system 100. Example of the user information include information regarding the user who has registered to use the wallet system 100, such as user ID, password, user name, user contact information (for example, street address, telephone number, email address, etc.), user terminal information (IP address), and a passcode at the time of settlement. Other examples of the user information include history information of a plurality of settlement methods, information related to payment methods registered as a deposit method. Furthermore, the user information further includes registration information indicating a plurality of settlement methods (settlement application names) registered as the settlement methods for the user terminal 3 and indicating user's balance associated with the user's terminal (user's terminal information (IP address)) in each of the plurality of settlement methods. The user ID and password stored in the user information storage unit 131 are used for an authentication process such as login to the wallet server 1.

The wallet information storage unit 132 stores wallet information related to the wallet of the wallet system 100. The wallet information is a virtual deposit/withdrawal account for electronic money. Specifically, the wallet information includes, for example, user ID, an electronic money balance, an electronic money deposit history, an electronic money usage history, or the like.

The settlement information storage unit 133 stores settlement information related to the settlement using the wallet system 100. Examples of the settlement information include user ID, a settlement method used for settlement (for example, electronic money payment, (contactless settlement), scan payment, code payment, etc.), settlement history, and history information of a plurality of settlement methods.

The shop information storage unit 134 stores shop information including: shop position information of each of the plurality of shops; one or more settlement methods usable in each of the plurality of shops; budget information indicating the budget for each of the plurality of shops; vendor information indicating each of vendors (for example, convenience store, general store, etc.) of the plurality of shops, which are associated with each other. In addition to the shop position information (street address), the shop information storage unit 134 may store the shop name, service period, telephone number, or the like.

Next, the configuration of the settlement provider server 2 will be described. The settlement provider server 2 is a server for managing user's accounts and credit cards. The settlement provider server 2 is provided in financial institutions (for example, banks, credit association, credit unions, labor banks, etc.) and credit card companies. The settlement provider server 2 includes a control unit 21, a communication unit 22, and a storage unit 23. The control unit 21, the communication unit 22, and the storage unit 23 have the functions similar to the control unit 11, the communication unit 12, and the storage unit 13, respectively, and thus, detailed description thereof will be omitted.

The storage unit 23 stores account information and credit card information for each of users of the wallet system 100. Examples of the account information include the user's name, account number, account balance, deposit/withdrawal history, or the like. The credit card information includes, for example, the user's name, credit card number, credit card expiration date, usage limit amount, card usage history, or the like.

Next, the configuration of the user terminal 3 will be described. Examples of the user terminal 3 include smartphones, mobile phones, tablet terminals, wearable computers, personal computers, car navigation systems mounted on vehicles, or the like owned by the user. The user terminal 3 may be any terminal as long as it may exchange information with the wallet server 1.

The user terminal 3 includes a control unit 31 (first processor), a communication unit 32, a storage unit 33, a short-range wireless communication unit 34, a display unit 35, an operation unit 36, an imaging unit 37, and a position acquisition unit 38. The communication unit 32 has the function similar to the communication unit 12, and thus, detailed description thereof will be omitted.

The control unit 31 controls each of components of the user terminal 3. The control unit 31 includes a processor having hardware such as a CPU and a DSP, and memory (a main storage unit) formed of RAM, ROM, or the like. The control unit 31 loads the program stored in the storage unit 33 into the work area of the main storage unit and executes the program. Through execution of the program, the control unit 31 controls individual components. The control unit 31 functions as the display control unit 311 through the execution of the program.

The display control unit 311 controls the display content on the display unit 35. The display control unit 311 displays screens such as a member registration screen on which the user registers as a member, a login screen on which the user makes a login to the wallet system 100, a deposit screen on which the user performs deposit of electronic money to the wallet, and a settlement screen on which the user makes a settlement, or the like, on the display unit 35 based on the user's operations (touch operation, slide operation, pinch operation, flick operation, or the like) on the operation unit 36. In addition, the display control unit 311 causes each of screens to transition based on a user operation.

The storage unit 33 stores various types of screen data to be displayed on the display unit 35 by the display control unit 311. The storage unit 33 is actualized by using an HDD, an SSD, or the like. The storage unit 33 includes a user information storage unit 131, a wallet information storage unit 132, a settlement information storage unit 133, a shop information storage unit 134, or the like, as necessary.

The short-range wireless communication unit 34 has a communication function conforming to the standards such as Near field radio communication (NFC), Bluetooth (registered trademark) Low Energy (BLE), and Infrared Data Association (IrDA). For example, when making electronic money payment, the user terminal 3 performs short-range wireless communication with the shop terminal 4 through the short-range wireless communication unit 34.

The display unit 35 is actualized by using a liquid crystal display, an organic electroluminescent (EL) display, or the like, and displays various types of information and images under the control of the control unit 31.

The operation unit 36 is actualized by using a touch panel, a button, a switch, or the like, receives user's operation, and makes outputs corresponding to the received operation to the control unit 31.

The imaging unit 37 captures an image of a predetermined field of view, and outputs the captured image (image data) to the control unit 31. The imaging unit 37 is actualized by using one or more lenses and an image sensor such as a Charge Coupled Device (CCD) sensor or a Complementary Metal Oxide Semiconductor (CMOS) sensor.

The position acquisition unit 38 acquires position information regarding the current position of the user terminal 3 and outputs the acquired position information to the control unit 31. The position acquisition unit 38 is actualized by using a GPS sensor, receives signals from a plurality of GPS satellites and transmitting antennas, and acquires the position information of the user terminal 3 based on the received signals.

Next, the configuration of the shop terminal 4 will be described. The shop terminal 4 is provided in shops (member stores) where the wallet system 100 may be used. The shop terminal 4 includes a control unit 41, a communication unit 42, a storage unit 43, and a short-range wireless communication unit 44. The control unit 41, the communication unit 42, the storage unit 43, and the short-range wireless communication unit 44 have the configuration similar to the control unit 11, the communication unit 12, the storage unit 13, and the short-range wireless communication unit 34, respectively, and thus, detailed description thereof will be omitted.

Next, the configuration of the map server 5 will be described. The map server 5 includes a control unit 51, a storage unit 52, and a communication unit 53. The control unit 51 and the communication unit 53 have the configuration similar to the control unit 11 and the communication unit 12, and thus, detailed description thereof will be omitted.

The storage unit 52 is actualized by using an HDD, an SSD, or the like, and stores various map data. Here, examples of map data include maps, scale information, shops, business categories, or the like.

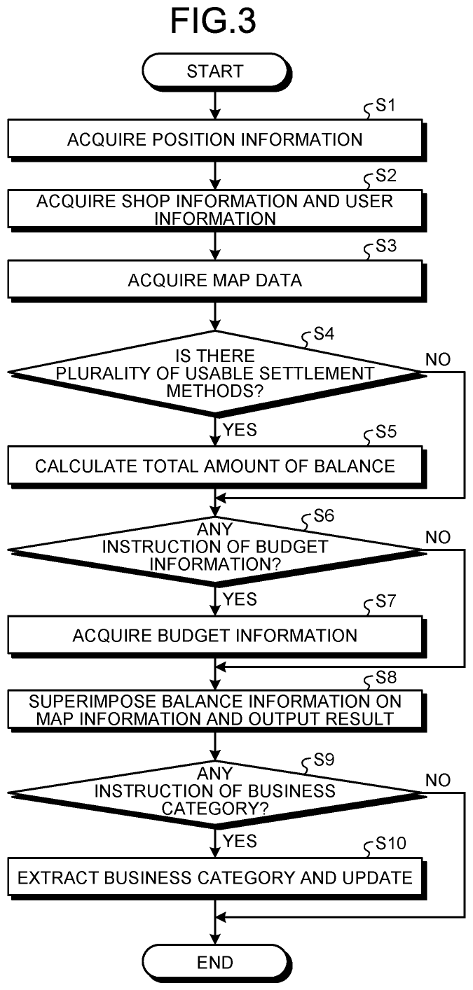

Next, processes executed by the wallet server 1 will be described. FIG. 3 is a flowchart illustrating an outline of the processes executed by the wallet server 1.

As illustrated in FIG. 3, the control unit 11 first acquires position information of the user terminal 3 acquired by the user (step S1). Specifically, the control unit 11 acquires the position information of the user terminal 3 acquired by the user by using the position acquisition unit 38 of the user terminal 3. The control unit 11 may acquire the street address input and designated by the user via the operation unit 36 of the user terminal 3, as the position information.

Subsequently, the control unit 11 acquires the shop information from the shop information storage unit 134 and acquires the user information from the user information storage unit 131 (step S2).

Thereafter, the control unit 11 acquires, from the map server 5, map data within a predetermined distance including this position information based on the position information acquired from the user terminal 3 via the network NW (step S3). In this case, the control unit 11 may acquire the map data according to the designated scale of the map from the user terminal 3, or may acquire the map data according to the preset scale.

Subsequently, based on the shop information, the control unit 11 determines whether the plurality of settlement methods registered in the user terminal 3 is usable at each of the plurality of shops on the map image based on the map data (step S4). When the control unit 11 has determined that the plurality of settlement method registered in the user terminal 3 at each of the plurality of shops on the map image based on the map data is usable based on the shop information (step S4: Yes), the control unit 11 calculates the total amount of the balance of the plurality of settlement methods registered in each of the user terminals 3 for the plurality of shops (step S5). With this configuration, the user is capable of grasping the total amount of the balance for the settlement method usable at each of the shops. In this case, the control unit 11 may output, to the user terminal 3, the service and the point return to be received at each of shops in accordance with the user's balance in the settlement method. After step S5, the wallet server 1 proceeds to step S6 described below. In contrast, in a case where the control unit 11 has determined that the plurality of settlement methods registered in the user terminal 3 at each of the plurality of shops on the map image based on the map data is not usable (step S4: No), the wallet server 1 proceeds to step S6 described below.

Thereafter, in a case where the control unit has been instructed from the user terminal 3 budget information displayed as the budget to be used in the shop (step S6: Yes), the control unit 11 acquires the budget information from the shop information stored in the shop information storage unit 134 (step S7). The control unit 11 may extract a shop appropriate for the budget input by the user terminal 3 from the shop information stored in the shop information storage unit 134. After step S7, the wallet server 1 proceeds to step S8 described below. In contrast, in a case where the control unit 11 has been instructed from the user terminal 3 the budget information displayed as the budget to be used in the shop (step S6: No), the wallet server 1 proceeds to step S8 described below.

Subsequently, the control unit 11 superimposes the balance information regarding the settlement method on individual positions of the plurality of shops on the map image and outputs the generated image to the user terminal 3 (step S8).

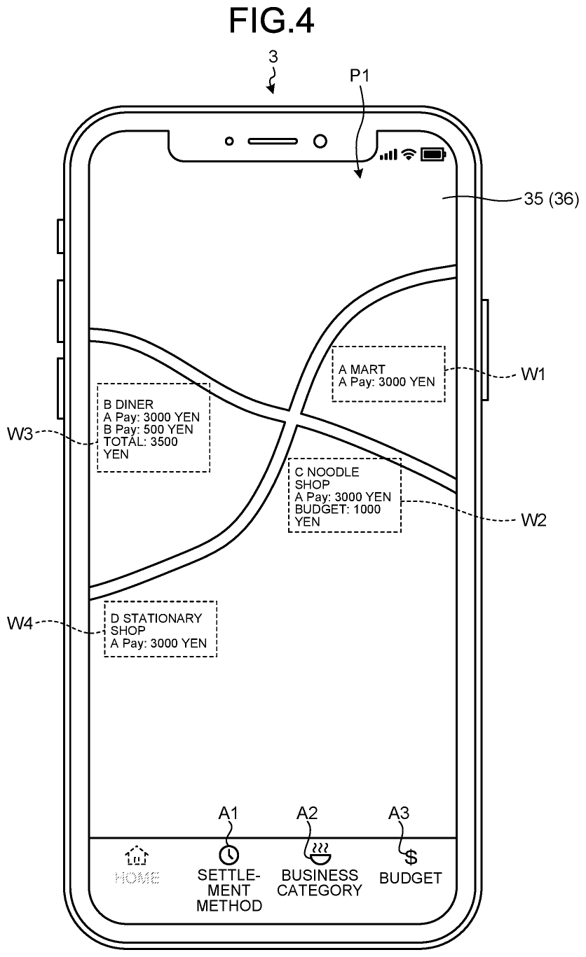

FIG. 4 is a view illustrating an example of an image displayed by the display unit 35 of the user terminal 3. As illustrated in FIG. 4, the control unit 11 outputs, to the user terminal 3, a map image obtained by superimposing the balance information on or in the vicinity of the position on the map image based on the map data corresponding to the shop position information regarding each of the plurality of shops within a predetermined distance in the position information of the user terminal 3. On a map image P1 displayed by the display unit 35 of the user terminal 3 illustrated in FIG. 4, pieces of balance information W1 to W4 including the balance and total amount regarding one or more settlement methods usable in each of the plurality of shops are superimposed. For example, the balance information W1 includes a display of “A Pay” as a usable settlement method for “A Mart” and a display of the balance 3,000 yen. The balance information W2 includes a display of “A Pay” as a usable settlement method for “C noodle shop” and a display of the balance 3,000 yen and the budget “1,000 yen”. Furthermore, the balance information W3 includes a display of “A Pay” and “B Pay” as usable settlement methods for “B diner”, with a display of the balance of “A Pay” and “B Pay” being 3,000 yen and 500 yen, respectively with a display of the total amount 3,500 yen. For example, the balance information W4 includes a display of “A Pay” as a usable settlement method for “D stationery shop”, and a display of the balance 3,000 yen. In addition, a lower area of the map image P1 displayed by the display unit 35 of the user terminal 3 includes icons A1 to A3. The icon A1 receives an input of a selection signal for selecting a settlement method desired by the user from among a plurality of settlement methods. The icon A2 receives an input of a selection signal to select a business category. The icon A3 receives an input of an instruction signal that instructs the budget.

Furthermore, in a case where each of the plurality of settlement methods is usable in each of the plurality of shops using the user terminal 3, the control unit 11 may output the balance regarding the most frequently used settlement method to the user terminal 3 based on the history information stored in the user information storage unit 131. For example, in a case where the user terminal 3 is capable of using “A Pay” and “B Pay”, the control unit 11 may output the most frequently used settlement method, for example, “A Pay” having the balance 3000 yen to the user terminal 3 based on the history information stored in the user information storage unit 131. With this configuration, the user may intuitively grasp the shop at which the user will be able to use the balance of the frequently used settlement methods. Furthermore, the control unit 11 may use an emphasized display of the usable settlement method when any of the plurality of settlement methods is usable in each of the plurality of shops. Here, the emphasized display means the display in which certain texts are made more prominent than other texts by enlarging the font, changing the font, changing the font color, using a special character in display, displaying avatars, reversing the background color (highlighting), or the like. For example, in the case illustrated in FIG. 4, the display unit 35 of the user terminal 3 may use an emphasized display for “A Pay” under the control of the display control unit 311. With this configuration, the user may intuitively grasp the usable settlement method.

Returning to FIG. 3, the description of step S9 and subsequent steps will be continued.

In a case where the business category of the shop is designated from the user terminal 3 (step S9: Yes), the control unit 11 extracts the business category designated by the user terminal 3 from among the plurality of shops included in the shop information acquired from the shop information storage unit 134 in step S2 and then updates the map image (step S10).

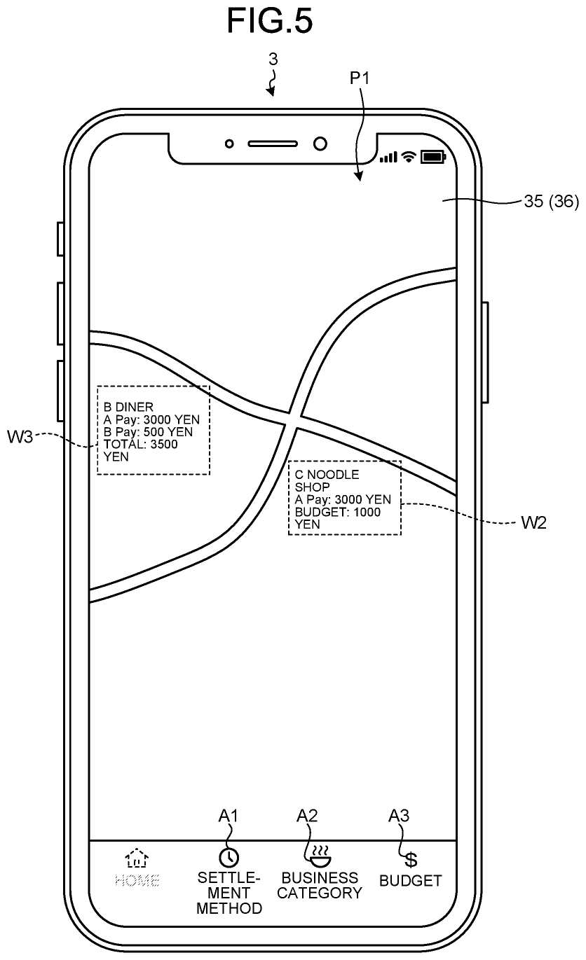

FIG. 5 is a view illustrating an example of another image displayed by the display unit 35 of the user terminal 3. As illustrated in FIG. 5, in a case where the icon A1 has been selected on the user terminal 3 and the business category has been designated as “food and drink” by the user, the control unit 11 extracts a shop that corresponds to food and drink from among a plurality of shops on the map image. With this operation, as illustrated in FIG. 5, “B diner” and “C noodle shop” are displayed on the map image P1 displayed by the display unit 35 of the user terminal 3. As a result, the user may intuitively grasp the balance of the settlement method usable in the desired business category. Furthermore, in a case where the budget is instructed by the user terminal 3, the control unit 11 may extract a shop for which the balance is higher than the budget from among the plurality of shops within a predetermined distance in the position information of the user terminal 3 based on the balance usable by the user with the settlement method in each of the plurality of shops and on the budget information of the shop information stored in the shop information storage unit 134, and may output the extracted information to the user terminal 3. This enables the user to select a shop appropriate for the balance. In this case, the control unit 11 may output, to the user terminal 3, the service and the point return to be received at each of shops in accordance with the user's balance in the settlement method. After step S10, the wallet server 1 ends this process. In contrast, in a case where the business category of the shop is not designated from the user terminal 3 (step S9: No), the wallet server 1 ends this process.

According to the embodiment described above, the control unit 11 outputs the balance information in which the shop position information regarding the shop and the balance regarding the settlement method usable on the user terminal 3 are associated with each other to the user terminal 3 based on the position information of the user terminal 3, the shop information, and the user information. This enables the user to have prior knowledge of the balance regarding the settlement method corresponding to each of the shops.

Furthermore, according to the embodiment, the control unit 11 acquires map data within a predetermined distance including the position information of the user terminal 3 via the network NW, and superimposes balance information on or in the vicinity of the position on the map image P1 based on the map data corresponding to the shop position information of each of the plurality of shops, and outputs the generated image to the user terminal 3. This enables the user to intuitively and easily grasp the balance of the settlement method corresponding to each of the shops on the map image P1.

Furthermore, according to the embodiment, the control unit 11 superimposes, for each of shops, the total amount obtained by adding up the balance regarding the plurality of settlement methods usable on the user terminal 3, on or in the vicinity of the position on the map image based on the map data corresponding to the shop position information of each of the plurality of shops, and outputs the result to the user terminal 3. This enables the user to have prior knowledge of the total amount of money that may be used for each of shops.

Furthermore, according to the embodiment, the control unit 11 outputs the balance information that includes the budget information regarding the budget of each of the plurality of shops, to the user terminal 3. This enables the user to grasp the budget for each of the shops.

Furthermore, according to the embodiment, the control unit 11 extracts a shop for which the balance is higher than the budget from among the plurality of shops within a predetermined distance in the position information of the user terminal 3 based on the balance regarding the settlement method and the budget information input from the user terminal 3, and outputs the extracted shop to the user terminal 3. Therefore, the user may grasp the shop where the balance is sufficient for the settlement method usable on the user terminal 3.

Furthermore, according to the embodiment, the control unit 11 selects a designated business category from among the plurality of shops within a predetermined distance in the position information of the user terminal 3 based on the designated business category input from the user terminal 3 and business category information stored in the shop information storage unit 134, and outputs the selected business category to the user terminal 3. This enables the user to grasp the balance of the settlement method at the desired shop.

Furthermore, according to the embodiment, in a case where each of the plurality of settlement methods is usable in each of the plurality of shops using the user terminal 3, the control unit 11 outputs the balance regarding the most frequently used settlement method to the user terminal 3 based on the history information stored in the user information storage unit 131. With this procedure, the user may intuitively grasp the shop at which the user will be able to use the balance of the frequently used settlement methods.

In the embodiment, the control unit 11 superimposes the balance information onto the shop position on the map image. However, the present disclosure is not limited to this, and the control unit 11 may output the street address of the shop position and the balance information to the user terminal 3.

Furthermore, in the wallet system according to the embodiment, the “unit” may be read as “circuit” or the like. For example, the control unit may be replaced with a control circuit.

Furthermore, the programs to be executed by the wallet system according to the embodiment are provided as file data of an installable format or an executable format in a state of being stored in a computer-readable recording medium such as a CD-ROM, flexible disk (FD), CD-R, Digital Versatile Disk (DVD), USB medium, flash drive, or the like.

Furthermore, the program to be executed by the wallet system according to the embodiment may be stored on a computer connected to a network such as the Internet so as to be downloaded via the network to be provided.

In the description of the flowcharts in the present specification, although the expressions “first”, “next”, “subsequently”, or the like are used to clarify a processing order of the steps, the processing order to carry out the present embodiments shall not be defined uniquely by these expressions. That is, the processing order in each of the flowcharts described in the present specification may be changed unless it is inconsistent.

According to the present disclosure, it is possible to have prior knowledge of the balance of the settlement methods corresponding to individual shops.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising
a processor comprising hardware, the processor being configured to:
acquire position information of a terminal;
acquire shop information in which shop position information of each of a plurality of shops and one or more settlement methods usable in each of the plurality of shops are associated with each other, and acquires user information in which the plurality of settlement methods registered on the terminal and user's balance linked with the terminal for each of the plurality of settlement methods are associated with each other; and
output balance information in which the shop position information regarding a shop and the balance regarding the settlement method usable on the terminal are associated with each other to the terminal based on the position information, the shop information, and the user information.

2. The server according to claim 1, wherein the processor is configured to:
acquire map data for a range within a predetermined distance including the position information; and
superimpose the balance information on or in a vicinity of the position on the map image based on the map data corresponding to the shop position information of each of the plurality of shops, and then outputs the generated information to the terminal.

3. The server according to claim 2, wherein the processor is configured to:
determine a usable settlement method among the plurality of settlement methods registered in the terminal for each of the plurality of shops on the map image based on the shop information;
calculate, for each of the plurality of shops, a total amount of the balance obtained by adding up the amounts of balance regarding the plurality of usable settlement methods; and
output information obtained by including the total amount into the balance information, to the terminal.

4. The server according to claim 2, wherein
the shop information further includes budget information regarding a budget for each of the plurality of shops, and
the processor is configured to output information obtained by including the budget information into the balance information, to the terminal.

5. The server according to claim 4, wherein the processor is configured to:
extract, in a case where a budget is instructed from the terminal to the processor, a shop for which the balance is higher than the budget instructed from the terminal from among the plurality of shops within a predetermined distance range on the position information based on the balance and the budget information; and
output the extracted information to the terminal.

6. The server according to claim 2, wherein
the shop information further includes business category information regarding a business category of each of the plurality of shops, and
the processor is configured to:
select, in a case where a designated business category in which the business category is designated has been input to the processor from the terminal, the designated business category from among the plurality of shops within a predetermined distance range in the position information based on the designated business category and the business category information; and
output the selected designated business category to the terminal.

7. The server according to claim 2, wherein
the user information further includes history information of the plurality of settlement methods registered in the terminal, and
the processor is configured to:
determine whether each of the plurality of settlement methods is usable at each of the plurality of shops on the map image by using the terminal; and
output the balance of the most frequently used settlement method to the terminal based on the history information in a case where it is determined that each of the plurality of settlement methods is usable at each of the plurality of shops by using the terminal.

8. A wallet system comprising:
a terminal comprising a first processor comprising hardware, the first processor being configured to acquire position information; and
a server comprising a second processor comprising hardware, the second processor being configured to
acquire position information of the terminal,
acquire shop information in which shop position information of each of a plurality of shops and one or more settlement methods usable in each of the plurality of shops are associated with each other, and acquire user information in which the plurality of settlement methods registered on the terminal and user's balance linked with the terminal for each of the plurality of settlement methods are associated with each other, and
output balance information in which the shop position information regarding a shop and the balance regarding the settlement method usable on the terminal are associated with each other to the terminal based on the position information, the shop information, and the user information.

9. The wallet system according to claim 8, wherein the second processor is configured to:
acquire map data for a range within a predetermined distance including the position information; and
superimpose the balance information on or in a vicinity of the position on the map image based on the map data corresponding to the shop position information of each of the plurality of shops, and then outputs the generated information to the terminal.

10. The wallet system according to claim 9, wherein the second processor is configured to:
determine a usable settlement method among the plurality of settlement methods registered in the terminal, for each of the plurality of shops on the map image, based on the shop information;
calculate, for each of the plurality of shops, a total amount of the balance obtained by adding up the balance regarding the plurality of usable settlement methods; and
output information obtained by including the total amount into the balance information, to the terminal.

11. The wallet system according to claim 9, wherein
the shop information further includes budget information regarding a budget for each of the plurality of shops, and
the second processor is configured to transmit information obtained by including the budget information into the balance information, to the terminal.

12. The wallet system according to claim 11, wherein
the first processor is configured to transmit the budget to the server, and
the second processor is configured to
extract, in a case where a budget is instructed from the terminal to the second processor, a shop for which the balance is higher than the budget instructed from the terminal from among the plurality of shops within a predetermined distance range on the position information based on the balance and the budget information, and
output the extracted information to the terminal.

13. The wallet system according to claim 9, wherein
the first processor is configured to
acquire a designated business category in which the business category is designated, and
output the designated business category to the server,
the shop information further includes business category information regarding the business category of each of the plurality of shops, and
the second processor is configured to
select, in a case where the designated business category has been input to the second processor, the designated business category from among the plurality of shops within a predetermined distance range in the position information based on the designated business category and the business category information, and
output the selected information to the terminal.

14. The wallet system according to claim 9, wherein
the user information further includes history information regarding the plurality of settlement methods registered in the terminal, and
the second processor is configured to
determine whether each of the plurality of settlement methods is usable at each of the plurality of shops on the map image by using the terminal, and
output the balance of the most frequently used settlement method to the terminal based on the history information in a case where it is determined that each of the plurality of settlement methods is usable at each of the plurality of shops by using the terminal.

15. A non-transitory computer-readable recording medium on which an executable program is recorded, the program causing a processor of a computer to execute:
acquiring position information of a terminal;
acquiring shop information in which shop position information of each of a plurality of shops and one or more settlement methods usable in each of the plurality of shops are associated with each other, as well as acquiring user information in which the plurality of settlement methods registered on the terminal and user's balance linked with the terminal for each of the plurality of settlement methods are associated with each other; and
outputting balance information in which the shop position information regarding a shop and the balance regarding the settlement method usable on the terminal are associated with each other to the terminal based on the position information, the shop information, and the user information.

16. The non-transitory computer-readable recording medium according to claim 15, wherein the program causes the processor to execute:
acquiring map data for a range within a predetermined distance including the position information; and
superimposing the balance information on or in a vicinity of the position on the map image based on the map data corresponding to the shop position information of each of the plurality of shops, and then outputting the generated information to the terminal.

17. The non-transitory computer-readable recording medium according to claim 16, wherein the program causes the processor to execute:
determining a usable settlement method among the plurality of settlement methods registered in the terminal, for each of the plurality of shops on the map image, based on the shop information;
calculating, for each of the plurality of shops, a total amount of the balance obtained by adding up the balance regarding the plurality of usable settlement methods; and
outputting information obtained by including the total amount into the balance information, to the terminal.

18. The non-transitory computer-readable recording medium according to claim 16, wherein
the shop information further includes budget information regarding budget for each of the plurality of shops, and
the program causes the processor to execute outputting information obtained by including the budget information into the balance information to the terminal.

19. The non-transitory computer-readable recording medium according to claim 18, wherein the program causes the processor to execute:
extracting, in a case where a budget is instructed from the terminal to the processor, a shop for which the balance is higher than the budget instructed from the terminal from among the plurality of shops within a predetermined distance range on the position information based on the balance and the budget information; and
outputting the extracted information to the terminal.

20. A method of notifying, the method comprising:
acquiring position information of a terminal;
acquiring shop information in which shop position information of each of a plurality of shops and one or more settlement methods usable in each of the plurality of shops are associated with each other, as well as acquiring user information in which the plurality of settlement methods registered on the terminal and user's balance linked with the terminal for each of the plurality of settlement methods are associated with each other; and
outputting balance information in which the shop position information regarding a shop and the balance regarding the settlement method usable on the terminal are associated with each other to the terminal based on the position information, the shop information, and the user information.
